(19) United States
(12) Patent Application Publication
(10) Pub. No.: US 2020/0366140 A1
(43) Pub. Date: Nov. 19, 2020

(54) STATOR AND ELECTRIC MOTOR

(71) Applicant: Brose Fahrzeugteile SE & Co. Kommanditgesellschaft, Würzburg, Würzburg (DE)

(72) Inventor: Stephan ROOS, Wertheim-Höhefeld (DE)

(73) Assignee: Brose Fahrzeugteile SE & Co. Kommanditgesellschaft, Würzburg, Würzburg (DE)

(21) Appl. No.: 16/966,577

(22) PCT Filed: Jan. 31, 2019
(86) PCT No.: PCT/EP2019/052340

§ 371 Date: Jul. 31, 2020

(30) Foreign Application Priority Data
Feb. 2, 2018 (DE) 10 2018 201 643.7

(51) Int. Cl. H02K 1/18; F04B 17/03; F04B 15/02; F04B 53/16; F16B 7/04

(52) U.S. Cl. CPC H02K 1/185; F04B 17/03; F16B 7/0406; F04B 53/16; F04B 15/02

(57) ABSTRACT

An electric motor having a stator, in particular for an electrical machine, comprising a shell body which encloses an essentially cylindrical cavity with an axis, and at least one auxiliary adjustment device fixed to an end face of the shell body.

### CROSS-REFERENCE TO RELATED APPLICATIONS

This application is the U.S. National Phase of PCT Application No. PCT/EP2019/052340 filed on Jan. 31, 2019, which claims priority to German Patent Application No. DE 10 2018 201 643.7, filed on Feb. 2, 2018, the disclosures of which are hereby incorporated in their entirety by reference herein.

### TECHNICAL FIELD

The present disclosure relates to a stator for use in an electric machine.

### BACKGROUND

Electrical machines, such as electric motors, comprise a fixed stator and a rotor having a rotatably supported bearing. An air gap between the rotor and the stator has a negative effect on the performance and noise of the electric machine and should therefore be kept to a minimum. However, the smaller the air gap, the smaller the tolerance range for decentering the stator with respect to the rotor.

### SUMMARY

One or more objects of the present disclosure may be to provide improved centering of a stator, which is to be attached to a further component.

As an example, a stator, for use in an electric machine, may be provided with a shell body which encloses a substantially cylindrical cavity having an axis, and with at least one auxiliary adjustment device attached to an end face of the shell body.

According to one or more embodiments, an electric motor is provided including a stator and a further component with at least one coupling element that may be configured to engage the at least one auxiliary adjustment device of the stator, the auxiliary adjustment device forming a fastening device together with the coupling element.

In one or more embodiments, a mechanism may be integrated into the shell body of the stator for the attachment of a stator to a further component. The mechanism may simultaneously ensure appropriate or desired centering of the stator. The auxiliary adjustment device provides compensation for any deviations in the positions of the individual elements which are provided for attaching the stator to the further component. This may provide improved assembly of an electrical machine that includes the stator, since no particular production step is necessary for the centering itself. The risk of incorrect assembly may also be reduced.

According to an embodiment of the stator, the auxiliary adjustment device may include a projection. This projection may be formed integrally with the shell body. The projection may also be spring-loaded in a plane perpendicular to the axis. According to this exemplary embodiment, the shell body may be manufactured in one step with the auxiliary adjustment device. This provides for a simple check whether the auxiliary adjustment device is within a specified tolerance range before the shell body is processed further.

According to an alternative embodiment, the auxiliary adjustment device may include a recess in the shell body. This recess may be created by drilling, for example. A shell body without projections may be more compact than a shell body having projections. This may be advantageous, for example, when transporting a large number of shell bodies, since they may be arranged in a space-saving manner.

In accordance with a further embodiment, the auxiliary adjustment device may also include a spring element. This spring element may be arranged within the recess of the shell body and may be configured to be loadable in a plane perpendicular to the axis. This is may be advantageous if the coupling elements of the further component are to be configured to be rigid projections.

In accordance with an alternative further embodiment, the auxiliary adjustment device may also include a clamping element. This clamping element may be configured to be spring-loaded in a plane perpendicular to the axis and may be advantageously configured to be insertable into the recess and also removable therefrom again, and the clamping element protrudes from the recess. According to this embodiment, the most heavily loaded element of the auxiliary adjustment device is configured to be a separate element. The clamping element may thus be replaced easily, which facilitates maintenance work on the electrical machine.

According to a further embodiment, the clamping element may be configured to be a clamping sleeve. Clamping sleeves may have a simple implementation of a suitable clamping element. This facilitates and improves the overall production of the stator.

According to another exemplary embodiment, the stator may include at least two auxiliary adjustment devices. The auxiliary adjustment devices may be arranged rotationally symmetrically around the axis. This creates several, preferably isotropically distributed, degrees of freedom for centering the stator. Thereby the acceptable tolerance range for the production of one of the several adjustment devices is increased.

According to an exemplary embodiment of the electric motor, a rotor corresponding to the stator may be provided. The rotor may also be arranged at the further component by means of a shaft. In this embodiment, the stator is centered with respect to the rotor only by the further component. This facilitates the production of the electric motor, since a reduced number of individual steps is required for the production.

According to another exemplary embodiment of the electric motor, a clamping element may be provided. The clamping element may advantageously press the stator from a side opposite the further component against the further component. The clamping element supports the attachment of the stator to the further component. Thereby, the auxiliary adjustment device may be configured with a stronger focus on centering and less on fastening.

The above-mentioned embodiments may be combined with each other in any sensible way. Further possible embodiments and configurations of the invention also include combinations of features of the invention which are not explicitly mentioned but which are described above or in the following with respect to exemplary embodiments. As an example, the skilled person may also add individual aspects as improvements or additions to the respective basic embodiment of the present invention.

### BRIEF DESCRIPTION OF THE DRAWINGS

The present invention is discussed in more detail below on the basis of the exemplary embodiments shown in the figures, wherein:

FIG. 1 shows a schematic diagonal view according to an exemplary embodiment of a stator;

FIG. 2 is a schematic cross-section according to an exemplary embodiment of an electric motor;

FIG. 3 is a schematic side view according to a further exemplary embodiment of an electric motor.

The enclosed figures are intended to provide a further understanding of the embodiments of the present invention. They illustrate embodiments and serve in connection with the description to explain the principles and concepts of the present invention. Further embodiments and many of the benefits mentioned above result when taken in combination with the figures. The elements shown in the figures are not necessarily drawn to scale.

In the figures of the drawing, like elements, features and components, which are identical in function and provide the same effect, are each indicated by the same reference signs, unless otherwise stated.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The centering of the stator with respect to the rotor is usually solved by means of a housing of the electrical machine, as disclosed for example in document DE 10 2009 010 177 A1. In order to use electric motors in the automotive sector, e.g. for power windows, adjustment of exterior mirrors, adjustment of driver's seats, etc., however, the electric motor should be configured to be as compact as possible. In order to be able to configure the electric motor without housing, the stator and rotor of the electric motor are attached to further components of the drive, such as housing components.

In the automotive sector, however, it is common practice nowadays to obtain individual components from third party suppliers and install them in the vehicle in a later assembly step. However, the conditions of industrial production in terms of cost and time efficiency lead to an inaccuracy in the production of the individual components, at least in the sub-millimeter range, which cannot be prevented in most cases. Suppliers are therefore required to provide fastening systems that allow a certain amount of leeway for readjustment during assembly of the components.

Document DE 10 2014 007 568 A1 discloses a solution with round screws and elongated recesses. However, this solution requires manual adjustment of the stator centering, which limits the possible efficiency of industrial production, as opposed to a possibly more automatic centering. Furthermore, the solution disclosed in document DE 10 2014 007 568 A1 requires a protruding section of the stator body, which in turn does not support the requirement of the electric motor to be as compact as possible.

Therefore, it would be helpful to provide an improved solution.

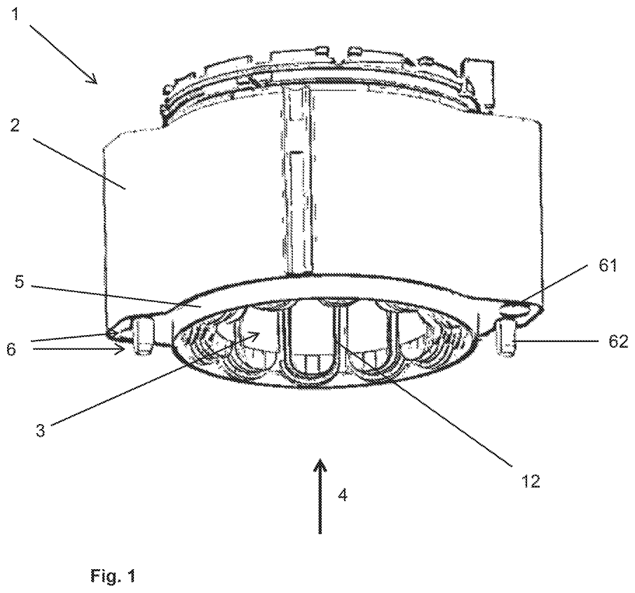

FIG. 1 shows a schematic representation of a stator 1 when viewed from below. The stator may include a shell body 2, which encloses a cylindrical cavity 3. Within the cylindrical cavity 3, a large number of coils 12 of the stator 1 are arranged along the inner surface of the shell body 2. In FIG. 1, the axis 4 of the cylindrical cavity 3 is aligned vertically. A total of four auxiliary adjustment devices 6 are attached to the lower end face 5. The auxiliary adjustment devices 6 are arranged in pairs, respectively. The two pairs are arranged symmetrically on opposite sides of the cavity 3 with respect to the axis 4. In the example shown, the auxiliary adjustment devices 6 are each provided as a recess 61 and a clamping element 62. One auxiliary adjustment device 6 of each pair is shown with the clamping element 62 inserted into recess 61. In the case of the other auxiliary adjustment devices 6, the clamping element 62 is omitted in order to provide a better representation of the respective recess 61.

According to one or more embodiments, the clamping elements 62 may be clamping sleeves. During assembly of stator 1, the clamping elements 62 are inserted into coupling elements 10 of a further component 8, which are configured to be corresponding recesses. If there are slight deviations in the positioning of the auxiliary adjustment devices 6 and/or the coupling elements 10, a force is applied by the coupling elements 10 in a plane perpendicular to axis 4. The clamping elements 64 are urged in this direction thereby reducing their corresponding expansion. This compensates for the deviation in positioning whereby the stator 1 is brought into its desired centered position.

The adjustment of the auxiliary adjustment device with respect to the corresponding coupling element may be relatively important for the present disclosure. The specific configurations of the individual elements of the auxiliary adjustment device disclosed herein may be interchanged with the specific configurations of the corresponding coupling elements. Thus, for example, the auxiliary adjustment devices 6 may also comprise projections which are formed integrally with the shell body 2, and may be spring-loaded in a plane perpendicular to axis 4. In this case, the coupling elements 10 of the further component 8 could be configured to be simple, corresponding holes.

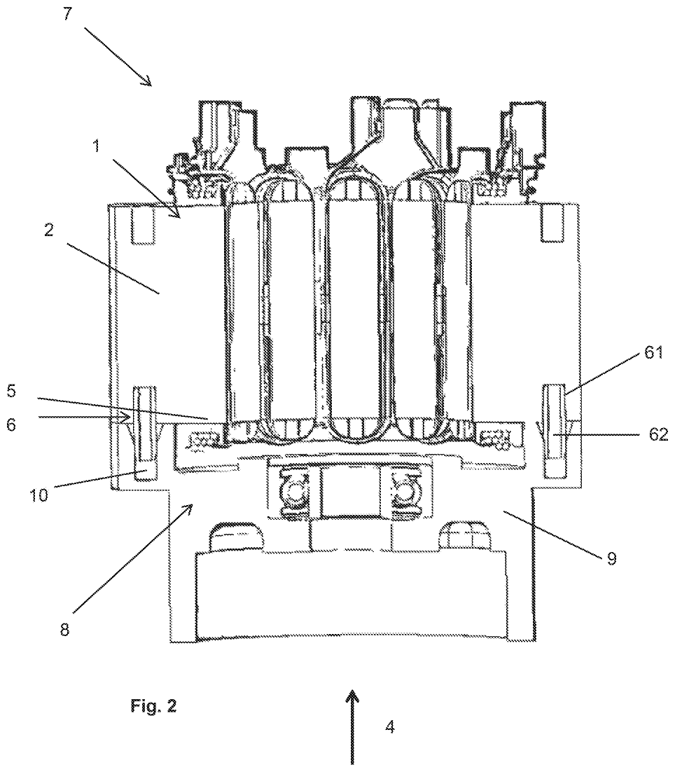

FIG. 2 shows a schematic sectional view of an electric motor 7. In this exemplary embodiment, the electric motor may include a stator 1 according to the exemplary embodiment of FIG. 1, and a further component 8, which is shown here in the form of a pump housing. The further component 8 is arranged below stator 1 in FIG. 2. Component 8 has a housing 9, which has coupling elements 10 corresponding to the auxiliary adjustment devices 6, which in this case are configured to be drill holes. In this view it is also visible that the stator 1 also may include recesses 62 on the upper end face 5 of the shell body, which may also serve to form auxiliary adjustment devices 6.

A rotor of the electric motor 7 which is centrally arranged on the component 8 is not visible in the view shown in FIG. 2. The clamping elements 62 are inserted both in the recesses 61 on the lower end face 5 of the shell body 2 and in the drill holes of the further component 8. The lateral outer surfaces of stator 1 and component 8 are congruent with each other, such that stator 1 is perfectly centered.

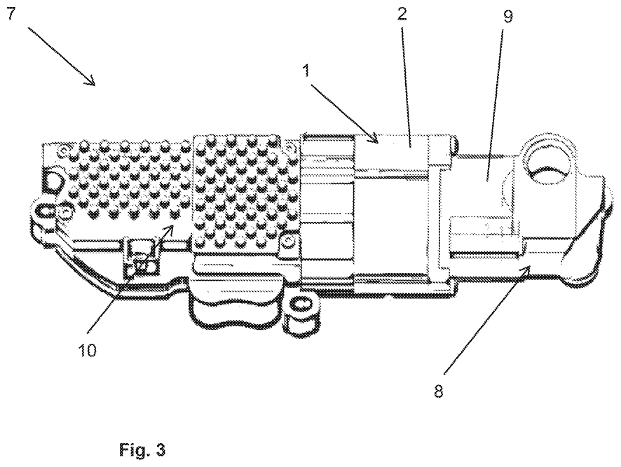

FIG. 3 shows a schematic side view of an electric motor 7. In FIG. 3, the electric motor 7 is rotated counterclockwise by 90°, as opposed to FIGS. 1 and 2. At a right end the electric motor may include a component 8 in the form of a pump housing. Shown to the left of component 8 there is a stator 1, which—further to the left—adjoins to a clamping element 11. In this exemplary embodiment, the clamping element 11 is configured to be an electronics housing.

Since stator 1 is arranged between component 8 and clamping element 11, component 8 and clamping element 11 apply, upon being fixedly mounted, opposing forces on stator 1 thereby fixing stator 1 by means of clamping. The resulting electric motor 7 may have a compact shape and may be suited for installation in an environment with space constrictions, such as in a passenger car.

Although the present invention has been fully described above by means of preferred exemplary embodiments, the present invention shall not be limited thereto, but may be modified in many various ways.

Thus, in addition to auxiliary adjustment devices shown here, further embodiments of the auxiliary adjustment devices 6 are also conceivable. For example, it may be provided that for the recesses 61 corresponding projections are attached to a further component 8 as coupling elements 10. These projections may be rigid, whereby additional resilient elements may be provided in recesses 61. Additionally, the coupling elements 10 may themselves be configured to be spring-loaded in a plane perpendicular to axis 4.

In contrast to the multi-part embodiment shown in the figures, the auxiliary adjustment devices 6 may also be configured to be projections integral with the shell body 2.

Alternative numbers and arrangements of the auxiliary adjustment devices 6 are also possible. For example, a number of three auxiliary adjustment devices 6, which are arranged rotationally symmetrically around the axis 4, each with an angle of 120°, are conceivable. In principle, depending on the space available for the installation of stator 1, the number and arrangement of the auxiliary adjustment devices 6 may be individually configured.

The auxiliary adjustment devices 6 and coupling elements 10 are shown here as components which may be loaded isotropically in the plane perpendicular to axis 4, for example cylindrically. Within the scope of the present invention, however, other embodiments are also conceivable, if it is appropriate for the specific stator. Thus, the auxiliary adjustment devices 6 may also have a cuboid shape and/or be configured to be spring-loadable in only one specific direction.

It is also conceivable to arrange several stators 1 one behind the other and to use one stator 1 each as a further component 8 with corresponding coupling elements 10 for another stator 1.

In the present description, the materials from which shell bodies 2 and/or auxiliary adjustment devices 6 are manufactured have not been defined in more detail. All materials commonly used in the automotive sector, especially for components of electric motors, such as metals, metal alloys and plastics may be used.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE SIGNS

1 Stator
2 Shell body
3 Cavity
4 Axis
5 Front face
6 Auxiliary adjustment device
7 Electric motor
8 Component
9 Housing
10 Coupling element
11 Clamping element
12 Coil
61 Recess
62 Clamping element

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An electric motor comprising:
a stator including a shell body substantially-enclosing cylindrical cavity defining an axis;
a first auxiliary adjustment device attached to an end face of the shell body; and
a further component including a housing including a coupling element, wherein
the first auxiliary adjustment device and the coupling element cooperatively form a fastening device.

2. The electric motor of claim 1,
wherein
the first auxiliary adjustment device includes a projection formed integrally with the shell body and spring-loaded in a plane perpendicular to the axis.

3. The electric motor of claim 1,
wherein
the first auxiliary adjustment device includes a recess defined by the shell body.

4. The electric motor of claim 3,
wherein
the first auxiliary adjustment device includes a spring element disposed within the recess of the shell body and biased in a plane perpendicular to the axis.

5. The electric motor of claim 3,
wherein
the first auxiliary adjustment device includes a clamping element configured to be inserted into and protrude from the recess and wherein the clamping element is spring-loaded in a plane perpendicular to the axis.

6. The electric motor of claim 5,
wherein
the clamping element is a clamping sleeve.

7. The electric motor of claim 1,
further comprising:
a second auxiliary adjustment device and a third auxiliary adjustment device each attached to the end face and arranged rotationally symmetrically about the axis.

8. The electric motor of claim 7,
further comprising:
a rotor configured to rotate about the stator; and
a rotor shaft extending from the rotor and coupled to the further component.

9. The electric motor of claim 7,
wherein the second auxiliary adjustment device includes a clamping element, wherein the clamping element biases the stator towards the further component from a side of the stator opposite the further component.

10. An oil pump comprising:
a pump housing defining a first recess and a second recess;
a stator; and
a shell body circumferentially surrounding the stator and including a first projection and a second projection each integrally formed to the shell body and extending from a face of the shell body, and wherein the first projection is disposed in the first recess and the second projection is disposed in the second recess.

11. The oil pump of claim 10, wherein the first projection and the second projection are each tapered between the face and a distal end of the first projection and the second projection.

12. The oil pump of claim 10, wherein the first projection and the second projection each have a cuboid shape.

13. The oil pump of claim 12, wherein the first projection and the second projection each have a rectangular cuboid shape.

14. The oil pump of claim 10, wherein the pump housing includes an end face, wherein the end face defines the first recess and the second recess.

15. The oil pump of claim 14, wherein the first recess and the second recess are each tapered from the end face to a bottom portion of the first recess and the second recess.

16. An oil pump for use in a vehicle comprising:
a pump housing including a first end defining a first number of recesses;
a coupling element configured to be coupled to a portion of the vehicle and including a second end defining a second number of recesses;
a stator disposed between the pump housing and the coupling element; and
a shell body circumferentially surrounding and attached to the stator, wherein the shell body includes,
a third end lying along the first end of the pump housing,
a first number of projections each integrally formed to and extending from the third end and disposed in each of the first number of recesses,
a fourth end lying along the second end of the coupling element, and
a second number of projections integrally formed to and extending from the fourth end and disposed in each of the second number of recesses.

17. The oil pump of claim 16, wherein a quantity of the first number of projections and a quantity of the second number of projections equal one another.

18. The oil pump of claim 17, wherein the quantity of the first number of projections is greater than or equal to four.

19. The oil pump of claim 18, wherein each of the projections of the first number or projections or the second number of projections are equidistantly spaced apart from one another.

20. The oil pump of claim 19, wherein at least some of the first number of projections, the second number of projections, the first number of recesses, or the second number of recesses are tapered so that the stator is substantially centered with respect to the pump housing or the coupling element or both the pump housing and the coupling element.
